(19) United States
(12) Patent Application Publication
(10) Pub. No.: US 2013/0192454 A1
(43) Pub. Date: Aug. 1, 2013

(54) CONTROL DEVICE FOR A RESERVOIR CHARGING PUMP OF THE BRAKING SYSTEM OF A VEHICLE AND METHOD FOR OPERATING A RESERVOIR CHARGING PUMP OF THE BRAKING SYSTEM OF A VEHICLE

(71) Applicant: Juergen Hachtel, Moeckmuehl (DE)

(72) Inventor: Juergen Hachtel, Moeckmuehl (DE)

(21) Appl. No.: 13/812,983

(22) PCT Filed: May 30, 2011
(86) PCT No.: PCT/EP2011/058826

§ 371 Date: Apr. 4, 2013

(30) Foreign Application Priority Data
Jul. 30, 2010 (DE) 102010038704.5

(51) Int. Cl. F15B 21/00

(52) U.S. Cl. CPC F15B 21/00
USPC 92/82; 92/261

(57) ABSTRACT

A control device for a reservoir charging pump of a braking system of a vehicle includes: an actuating device designed to actuate the reservoir charging pump into at least one normal mode having a normal rotational speed, and a receiving device designed to receive a variable provided by a vehicle-specific component with respect to a supply voltage provided to the reservoir charging pump. The actuating device is additionally designed to ascertain whether the variable received lies outside a normal value range that is specified for the normal mode, and, if necessary, to actuate the reservoir charging pump from the normal mode into at least one deviation mode having at least one setpoint rotational speed deviating from the normal rotational speed.

### BACKGROUND OF THE INVENTION

1. Field of the Invention

The present invention relates to a control device for a reservoir charging pump of the braking system of a vehicle, and a method for operating a reservoir charging pump of a braking system of a vehicle.

2. Description of the Related Art

Published German patent application document DE 199 35 371 A1 describes a method and a device for actuating components in a vehicle, particularly for actuating a pump for charging a pressure reservoir. In this context, it is proposed that one specify a pulse-no-pulse ratio of the pump motor controlled in a clock-pulsed manner, as a function of the vehicle and/or environmental noises, or of at least one noise-influencing variable.

From published German patent application document DE 102 15 392 A1 a method is known for actuating a reservoir charging pump of an electrohydraulic braking system. In this method, the reservoir charging pump is actuated to fill up a pressure reservoir of the electrohydraulic braking system, provided the pressure in the pressure reservoir falls below a specifiable switch-on threshold value. The switch-on threshold value is adjusted variably during travel operation, while taking into account at least one current state variable or operating variable of the vehicle, such as a temperature and/or a currently performed work consumed by friction.

### BRIEF SUMMARY OF THE INVENTION

In response to a deviation of the supply voltage provided to the reservoir charging pump from a normal value range, especially upon the occurrence of a voltage drop in the vehicle's own electrical system, the control device according to the present invention and the corresponding method enable the reduction in the currents flowing through a motor of the reservoir charging pump, in such a way that the vehicle component, such as the vehicle's electrical system, used to provide the supply voltage, is protected. In this way it may particularly be prevented that, in the case of a voltage drop in the vehicle's electrical system, a current having a comparably large current strength flows through the reservoir charging pump, and thus the vehicle's electrical system is loaded unnecessarily. This ensures a reliable maintaining of the vehicle operation. Below, we shall go into greater detail on the possibilities able to be implemented for reducing the currents through the reservoir charging pump, using the assured advantageous actuation of the operating mode of the reservoir charging pump.

Furthermore, using the control device and the corresponding method, it may be ensured that actuating electronics are not damaged based on too high a current flow through a motor of the reservoir charging pump. This is a further advantage, in addition to the prevented unnecessary loading of the vehicle electrical system based on too high a current flow through the motor of the reservoir charging pump.

One may also rewrite the functions described using the control device according to the present invention, and the corresponding method, in such a way that, in the case of a deviation of the electrical system voltage from the normal value range, particularly in the case of an undervoltage in the vehicle electrical system, via an advantageous actuation of the reservoir charging pump, damage to the actuating electronics and/or additional loading of the vehicle electrical system are avoided.

In one advantageous specific embodiment, the actuating device is designed, in addition, to ascertain whether the variable received lies within a specified first deviation value range and, if necessary, to actuate the reservoir charging pump into a first deviation mode while having a setpoint rotational speed greater than the normal rotational speed. The first setpoint rotational speed may, in particular, be greater than the normal rotational speed by a factor of at least 2, advantageously 2.5, especially 3. By raising the setpoint rotational speed, the strengths of the currents flowing through a motor of the reservoir charging pump and an actuating electronics are reduced. In this way, a power loss of the motor and/or of the actuating electronics are also reduced. This reduces the load on the vehicle's current supply component, such as the load on the vehicle electrical system.

Alternatively or in supplementation, the actuating device may be designed, in addition, to ascertain whether the variable received lies within a specified second deviation value range and, if necessary, to actuate the reservoir charging pump into a second deviation mode while having a second setpoint rotational speed equal to zero. In this way, particularly in the case of a significant voltage drop in the vehicle electrical system, the reservoir charging pump of the braking system is able to be transferred automatically to a standstill. Consequently, the energy still able to be drawn from the vehicle electrical system may be used for vehicle functions having the highest priority. This is advantageous, above all, provided the reservoir charging pump is used for charging a pressure reservoir, by the use of which the braking effect applied by the driver via the brake operating element is reinforcible. It is true that, in this case, after transferring the reservoir charging pump into a standstill, the driver has to exert a greater force on the brake operating element, such as the brake pedal, but the driver is able to brake the vehicle safely.

In one advantageous further development, the actuating device is additionally designed to ascertain whether the variable received lies between the first deviation value range and the second deviation value range, and, if necessary, to actuate the reservoir charging pump into a third deviation mode having a third setpoint rotational speed greater than the normal rotational speed, in which the startup of the reservoir charging pump is able to be forestalled, using the actuating device. By specifying a setpoint rotational speed greater than the normal rotational speed, the currents flowing through the motor of the reservoir charging pump and/or the actuating electronics are able to be reduced. In addition, because of the forestalling/preventing of a startup of the motor of the reservoir charging pump, it may be prevented that the comparatively high reservoir charging motor startup currents additionally load the vehicle electrical system, and that consequently the on-board voltage drops further. In spite of the maintaining of a base operation of the reservoir charging pump, one is thus able to avoid the unnecessary loading of the vehicle's electrical system.

The advantages described in the upper paragraphs are also implemented in response to the development of the control device as a subunit of the reservoir charging pump.

Also, the advantages named in the upper paragraphs are assured in a braking system having such a control device, a reservoir charging pump and a pressure reservoir, in which pressure is able to be built up using the reservoir charging pump.

In a preferred manner, the pressure reservoir may be connected to a master brake cylinder of the braking system in such a way that an inner pressure in at least one pressure chamber of the master brake cylinder is able to be raised using the pressure built up in the pressure reservoir. To do this, for example, the pressure reservoir may be hydraulically connected to an antechamber of the master brake cylinder. In this case, the pressure reservoir is particularly used to improve the ease of operation of the brake actuating element for the driver, who is relieved workwise during the braking of the vehicle. However, since in response to a deviation of the on-board voltage from a normal value range one may do without this ease of operation, this specific embodiment ensures a good safety standard of the vehicle equipped with it.

Moreover, the advantages described in the upper paragraphs are also ensured by a corresponding method for operating a reservoir charging pump of a braking system of a vehicle.

### BRIEF DESCRIPTION OF THE DRAWINGS

FIG. 1 shows a coordinate system for explaining a specific embodiment of the method for operating a reservoir charging pump of a vehicle's braking system.

FIG. 2 shows a schematic representation of a braking system having a control device for a reservoir charging pump.

### DETAILED DESCRIPTION OF THE INVENTION

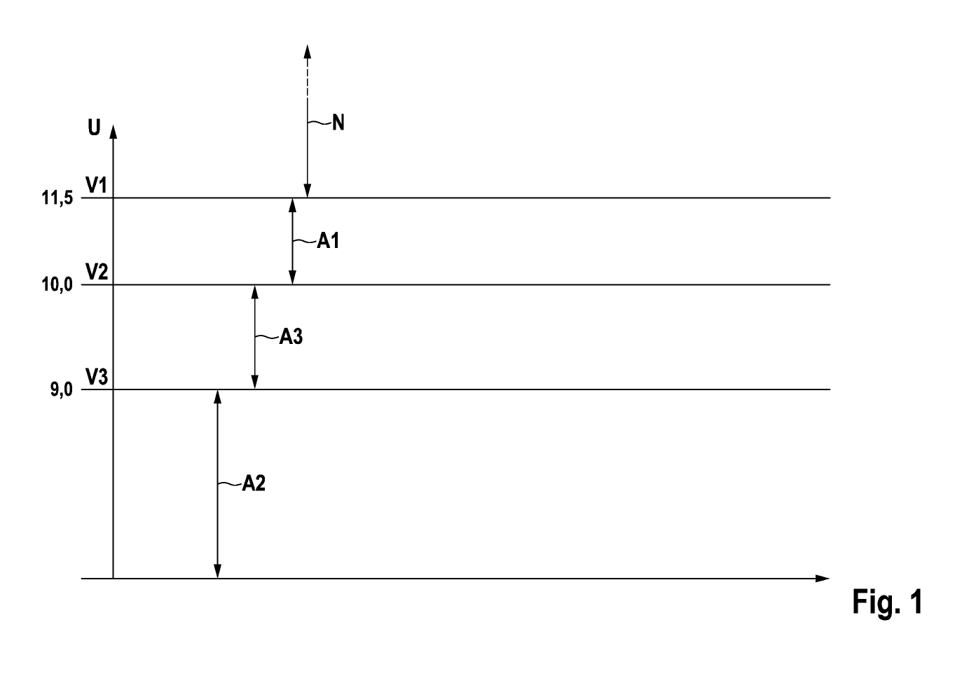

FIG. 1 shows a coordinate system for explaining a specific embodiment of the method for operating a reservoir charging pump of a vehicle's braking system. The ordinate of the coordinate system reflects an overall value range of an on-board voltage U of a vehicle's electrical system. We should point out, however, that the ability to use the method described here does not presuppose the providing of the supply voltage as on-board voltage U to the operable reservoir charging pump. No physical value has been assigned to the abscissa of the coordinate system shown.

In the method further described, a variable is ascertained with respect to a supply voltage provided for the operated reservoir charging pump. The variable ascertained may be a voltage value, for instance, particularly an on-board voltage U. The method described in this instance is, however, not restricted to the ascertainment of a voltage value as the variable with regard to the supply voltage.

Subsequently, it is ascertained whether the variable ascertained lies in a normal value range N specified for a normal mode of the reservoir charging pump. Normal value range N may be a first voltage range, for example. In one advantageous specific embodiment, during the ascertaining as to whether the ascertained variable lies in normal value range N, the ascertained value is compared to at least one first comparison value V1. The at least one first comparison value V1 may be a first voltage value, for example, in particular, a voltage of 11.5 V. The method step reflected in this paragraph is not, however, restricted to such an ascertaining of the inclusion of the variable ascertained in normal value range N.

Provided the variable ascertained is in the normal value range N, the reservoir charging pump is operated in the normal mode at the normal rotational speed specified for it. In a preferred manner, during a time interval in which the variable ascertained is in the normal value range N, no change takes place in a reservoir charging regulation in the normal mode. A motor of the reservoir charging pump (reservoir charging motor) is thus operated in the normal mode, at a fixed rotational speed specified for it, such as 1000 revolutions/min.

If the ascertained variable lies outside normal value range N, the reservoir charging pump is actuated from the normal mode to at least one deviation mode, using at least one setpoint rotational speed that deviates from the normal rotational speed. The possibilities described below of actuating the reservoir charging pump into the deviation modes described should be understood only in exemplary fashion.

For example, in the method it may also be ascertained whether the variable ascertained lies in a specified first deviation value range A1, in particular, a second voltage range. In particular, a variable below the first comparative value V1 may be compared to a second comparative value V2, such as a voltage of 10.0 V. If the variable ascertained lies in first deviation value range A1, the reservoir charging pump may be actuated into a first deviation mode having a first setpoint rotational speed, greater than the normal rotational speed. This is particularly advantageous provided first deviation range A1 is adjacent to normal value range N, and corresponds to a supply voltage below a normal supply voltage. Using the method step described here, particularly in response to a voltage drop in the vehicle electrical system, a power loss of the motor and/or the actuating electronics is thus able to be reduced. In this way, the vehicle electrical system load may be reduced. At the same time it is ensured that the reservoir charging pump, actuated into the deviation mode, continues to be usable for charging the pressure reservoir assigned to it. Consequently, in spite of the reduced vehicle electrical system load, a pressure may continue to be built up in the pressure reservoir, whose function will be discussed in greater detail below, using the reservoir charging pump actuated in the first deviation mode.

The first setpoint rotational speed may be greater than the normal rotational speed by a factor of at least 2, especially by a factor of at least 2.5, and preferably by a factor of at least 3. In particular, in the first deviation mode, the first setpoint rotational speed may be adjusted to the maximum possible setpoint rotational speed of the motor of the reservoir charging pump, such as to a setpoint rotational speed of 3000/min. The result is that the currents flowing through the motor and the actuating electronics of the reservoir charging pump, which are preferably clock-pulsed, become minimal. In this way, the above-mentioned advantage is reliably ensured.

In the same way it may be ascertained in another method step whether the variable ascertained lies in a specified second deviation value range A2, for instance, below a third comparative value V3, particularly below a voltage value of 9.0 V. If the variable ascertained lies in second deviation value range A2, the reservoir charging pump is actuated into a second deviation mode having a second setpoint rotational speed equal to zero. One may also rewrite the second deviation mode in such a way that a motor of the reservoir charging pump, that is already running, is stopped, and a startup of the motor of the reservoir charging pump actuated in the second deviation value range is forestalled/prevented. This actuating of the reservoir charging pump into the second deviation mode is particularly advantageous if a significant voltage drop of the supply voltage provided to the reservoir charging pump takes place. Consequently, it is ensured in such a situation that there is no load on the vehicle electrical system, based on the operation/startup of the motor of the reservoir charging pump.

Furthermore, it may be ascertained whether the variable ascertained lies in a third deviation value range A3, between first deviation value range A1 and second deviation value range A2. The third deviation value range may particularly be a third voltage range between the comparative values V2 and V3. If the variable ascertained lies in third deviation value range A3, then in the specific embodiment of the method described here, the reservoir charging pump is actuated into a third deviation mode having a third setpoint rotational speed greater than the normal rotational speed, in the third deviation mode additionally a startup of the resevoir charging pump being forestalled/prevented.

In a preferred manner, the third setpoint rotational speed is specified corresponding to the first setpoint rotational speed. For example, the third setpoint rotational speed may be greater than the normal rotational speed by a factor of at least 2, especially by a factor of at least 2.5, and preferably by a factor of at least 3, and/or may correspond to a maximum possible setpoint rotational speed of the motor of the reservoir charging pump, such as a setpoint rotational speed of 3000 revolutions/min. In this way, the advantages that are implementable by operating the reservoir charging pump in the first deviation mode are also ensured in the third deviation mode.

In addition, in the third deviation mode, because of the forestalling/preventing of a startup of the motor of the reservoir charging pump, it may be prevented that the high reservoir charging motor startup currents additionally load the vehicle electrical system. With that, an additional drop in the on-board voltage, based on withdrawn reservoir charging motor startup currents, is reliably preventable. This is very advantageous, since such reservoir charging motor startup currents, as a rule, are clearly greater than the currents of a stationary operation of the motor of the reservoir charging pump. For instance, although the currents of the stationary operation of the reservoir charging pump are in a range between 20-30 A, reservoir charging motor startup currents of about 100 A may occur.

The method described in the upper paragraphs ensures the maintaining of a vehicle operation in spite of a drop in the on-board voltage. The numbers quoted should be understood to be only exemplary, and may be adjusted individually to the vehicle electrical system of a vehicle. Consequently, the method is applicable to various vehicle electrical system types.

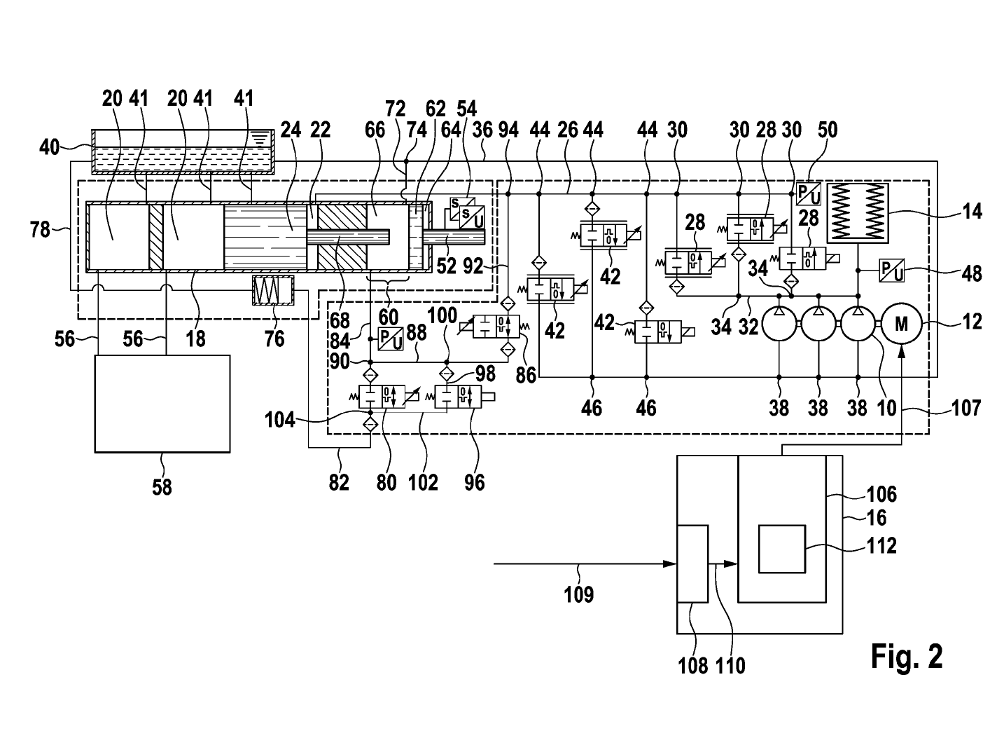

FIG. 2 shows a schematic representation of a braking system having a control device for a reservoir charging pump.

The schematically reproduced braking system has a reservoir charging pump 10, having a motor 12, by the use of which a pressure may be built up in a pressure reservoir 14. One may also rewrite this to say that pressure reservoir 14 is chargeable using reservoir charging pump 10. Pressure reservoir 14 may be developed particularly as a high-pressure reservoir. Control device 16 that is described more accurately below, for reservoir charging pump 10 is not, however, limited to charging such a pressure sensor 14. Similarly, the development of reservoir charging pump 10 as a three-piston pump should only be understood in an exemplary manner.

In the braking system, pressure reservoir 14 is connected to a master brake cylinder 18 of the braking system hydraulically in such a way that an inner pressure in at least one pressure chamber 20 of the master brake cylinder 18 is able to be raised using the pressure built up in the pressure reservoir 14. Master brake cylinder 18 may take the form of a tandem master brake cylinder. However, the subsequently described braking system is not limited to such a master brake cylinder 18.

In a preferred manner, pressure reservoir 14 is hydraulically connected to an antechamber 22 of master brake cylinder 18. By an antechamber 22 one may understand an inner volume of master brake cylinder 18, an adjustable component 24 of master brake cylinder 18 delimiting the antechamber 22 in such a way from the at least one pressure chamber 20 that an overall volume of antechamber 22 and the at least one pressure chamber 20 remains constant even in response to the adjusting of adjustable component 24. Thus a volume increase in antechamber 22 has the effect of pressing together the at least one pressure chamber 20, and in this way of a corresponding increase in the inner pressures in the at least one pressure chamber 20. Thus a volume increase in antechamber 22 has the effect of a volume increase in the at least one pressure chamber 20, and in this way of a reduction in the inner pressures of the at least one pressure chamber 20.

In the specific embodiment described here, pressure reservoir 14 thus functions as a brake booster of the braking system. One may also rewrite this to say that in the braking system, a usual brake booster is replaced by a hydraulic device which includes the reservoir charging pump 10 and the pressure reservoir 14. As will be described in greater detail below, the braking system shown, having the hydraulic device, may be used in a hybrid or an electric vehicle. The braking system described may therefore be designated as a HAS-hev (hydraulic actuation system for hybrid electrical vehicles).

Reservoir charging pump 10 and pressure reservoir 14 are hydraulically connected via a line 26 to antechamber 22. In this context, at least one pressure build-up valve 28 is situated in the hydraulic connection between pressure reservoir 14 and antechamber 22 in such a way that a brake medium volume is able to be shifted from pressure reservoir 14 through the at least one open pressure build-up valve 28 into antechamber 22. In particular, a plurality of pressure build-up valves 28 may be connected to a delivery side of reservoir charging pump 10 and pressure sensor 14 via branching points 30 developed in line 26, and via branching points 34 developed in an additional line 32. In the development of reservoir charging pump 10 as a three-piston pump, the use of three pressure build-up valves 28 is of advantage. However, the subsequently described braking system is not limited to a certain number of pressure build-up valves 28.

The intake side of reservoir charging pump 10 is connected to a braking medium reservoir 40 via at least one branching point 38 developed in a reservoir line 36. Braking medium reservoir 40 may be connected to the at least one pressure chamber 20 of master brake cylinder 18 via at least one continuous flow opening 41.

In a preferred manner, the intake side of reservoir charging pump 10 is also connected to antechamber 22 via at least one pressure reduction valve 42. In this case, after the opening of the at least one pressure reduction valve 42, a braking medium volume may be pumped from antechamber 22 through the at least one opened pressure reduction valve 42 into pressure reservoir 14, using reservoir charging pump 10. This has the effect of a rapid volume reduction in antechamber 22, and with that, a rapid pressure reduction in the at least one pressure chamber 20 of master brake cylinder 18. For example, a plurality of pressure reduction valves 42, in particular, three pressure reduction valves 42 may be connected on the input side to one each of branching points 44 developed in line 26, and on the output side to a branching point 46 developed in reservoir line 36.

The brake booster formed from reservoir charging pump 10 and pressure reservoir 14 may be controlled by at least one sensor 48 or 50. For example, a first sensor 48 may be positioned at the delivery side of reservoir charging pump 10 and pressure sensor 40. A second sensor 50, which may also be developed as a pressure sensor, is in this case preferably connected to line 26.

Via an opening and closing of valves 28 and 42, preferably while taking into account the provided sensor signals of the at least one sensor 48 or 50, the volume of antechamber 22 may be set in such a way that, in the at least one pressure chamber 20, an inner pressure corresponding to a setpoint vehicle deceleration, specified by an automatic speed control system (ACC) and/or an emergency automatic braking system may be actively set. Consequently, reservoir charging pump 10 and pressure reservoir 14 may be used in a braking system equipped with an automatic speed control system and/or an emergency automatic braking system.

In the same way, a driver is able to be supported during the operation of a brake operating element 52, for reducing the vehicle speed, by reservoir charging pump 10 and pressure reservoir 14. For instance, using at least one operating sensor 54, such as using a braking force sensor and/or a braking path sensor, a setpoint deceleration in the driving speed, specified by the driver, is able to be determined. Subsequently, using reservoir charging pump 10, pressure reservoir 14 and valves 28 and 42, the volume of antechamber 22 may actively be set so that, in at least one brake circuit 58 (shown here only schematically), that is hydraulically connected to the at least one pressure chamber 20 via a supply line 56 or in at least one wheel brake cylinder (not sketched), of the at least one brake circuit 48, there is present a desired braking pressure. We should point out that the braking system shown here is not limited to any certain development of the at least one brake circuit 58. We therefore do without accurate statements on the at least one brake circuit 58.

Reservoir charging pump 10, pressure sensor 14 and valves 28 and 42 thus ensure an improved braking convenience for the user of the braking system. In particular, in one advantageous method of functioning of reservoir charging pump 10, pressure reservoir 14 and valves 28 and 42, a multiple of a driver braking force exerted upon brake operating element 52 is able to be applied to adjustable component 24. Consequently, the driver himself does not have to exert the entire force for building up the desired braking pressure on brake operating element 52.

The braking system shown may also be used together with a generator (not sketched) for braking a vehicle. Using reservoir charging pump 10, pressure reservoir 14 and valves 28 and 42, in this case, the braking pressure present in the at least one brake circuit 58 may be varied, while taking into consideration an increase or a decrease in the generator braking torque. For instance, using the pumping out of a brake medium volume from antechamber 22 via the at least one opened pressure reduction valve 42, the braking pressure in the at least one brake circuit 58 is able to be reduced corresponding to the increase over time of the generator braking torque. In the same way, by transferring a brake medium volume from pressure reservoir 14, via the at least one pressure build-up valve 28 into antechamber 22, the braking pressure in the at least one brake circuit 58 is able to be increased in such a way that a reduction over time in the generator braking torque is compensated for. Thus, an advantageous masking of the generator braking torque is able to be executed, using reservoir charging pump 10, pressure reservoir 14 and valves 28 and 42.

In order to ensure additional operating convenience for the user of the braking system, a sensing cylinder 60 may be developed between brake activating element 52 and master brake cylinder 18. For example, brake operating element 52 (shown only schematically here) may be connected to an adjustable component 62 of sensing cylinder 60, which subdivides a total inner volume of sensing cylinder 60 into an antechamber 64 and a pressure chamber 66. In this case, adjustable component 24 of master brake cylinder 18 may be connected to a piston 68, which at least partially projects into pressure chamber 66 of sensing cylinder 60. In a preferred manner, the pressure in the pressure chamber is able to be varied via a pressure-adjusting device, which will be described in greater detail below.

By using such a sensing cylinder 60, together with a pressure-adjusting device, a restoring effect may be exerted upon brake operating element 52, that is able to be decoupled from the inner pressure in the at least one pressure chamber 20 of master brake cylinder 18. In spite of the varying of the braking pressure in the at least one brake circuit 58, so as to mask the generator braking torque, the driver senses, in this case, a standard type of brake feel (pedal feel). At the same time, the driver has the possibility of actively braking into master brake cylinder 18 via sensing cylinder 60.

Pressure chamber 66 of sensing cylinder 60 may be hydraulically connected to a branching point 74 developed in reservoir line 36 via a line 72. In a preferred manner, the hydraulic connection between pressure chamber 66 of sensing cylinder 60 and line 72 is developed as an opening which is closed in response to a light operation of brake operating element 53. By contrast, a hydraulic connection between pressure chamber 66 of sensing cylinder 60 and a spring 76 may be developed in such a way that even during a significant operation of brake operating element 52 it is not closed/sealed. Spring 76 may be connected via an additional reservoir line 78 to brake medium reservoir 40. The pressure in the pressure chamber may be set actively to a desired value, via a continuously adjustable valve 80, which is connected via a line 82 to spring 76, and via a line 84 to pressure chamber 66. Continuously adjustable valve 80 is thus also designated as a simulator valve. An additional continuously adjustable valve 86 is connected via a line 88 to a branching point 90 developed in line 84 and via a line 92 to a branching point 94 developed in line 26. This continuously adjustable valve 86 may also be drawn upon for setting the desired pressure in pressure chamber 66 of sensing cylinder 60. Furthermore, the braking system includes a deactivating valve 96, which is connected via a line 98 to a branching point 100 developed in line 88 and via a line 102 to a branching point 104 developed in line 82.

The applicability of additionally described control device 16 for reservoir charging pump 10 is, however, not limited to the above-described equipping of the braking system with components 18-104.

Control device 16 has an actuating device 106, which is designed to control reservoir charging pump 10 in at least one normal mode at a normal rotational speed, using a control signal 107. A receiving device 108 of control device 16 is designed to receive a variable provided by a vehicle-specific component (not shown) as a sensor and/or information signal 109, with respect to a supply voltage provided to reservoir charging pump 10. Examples of the providable variable have already been enumerated in the above description of the method. The component providing the variable may also be a sensor, for determining/measuring the variable, that is developed as a subunit of control device 16. The component may likewise be a sensor situated on the vehicle externally of the control device, or a central vehicle information output device.

Actuating device 106 is additionally designed to ascertain whether the variable received using a forwarding signal 110 lies in a normal value range specified/stored on an internal memory 112. Provided the variable received lies in the specified normal value range, reservoir charging pump 10 preferably continues to be operated/controlled in the normal mode, using control device 16.

If, however, the variable received lies outside the normal value range, actuating device 106 is designed to actuate reservoir charging pump 10 from the normal mode into at least one deviation mode having at least one setpoint rotational speed that deviates from the normal rotational speed.

In one advantageous specific embodiment, actuating device 106 is additionally designed to ascertain whether the variable received lies in a specified first deviation value range, in a specified second deviation value range, or between the first deviation value range and the second deviation value range, which do not intersect. The two deviation value ranges that are specified/stored on internal memory 112 lie outside the normal value range. Provided the variable received lies in the first deviation value range bordering on the normal value range, reservoir charging pump 10 is controlled/switched in a first deviation mode at a first setpoint rotational speed greater than the normal rotational speed. If the variable received lies in the second deviation value range that is at a greater distance from the normal value range, reservoir charging pump 10, using actuating device 106, may be controllable in a second deviation mode at a second setpoint rotational speed equal to zero. Provided the variable received lies between the first deviation value range and the second deviation value range, reservoir charging pump 10, using actuating device 106, is controllable in a third deviation mode having a third setpoint rotational speed greater than the normal rotational speed, in which a startup of reservoir charging pump 10 is forestallable using actuating device 106.

Thus, using control device 16, the above carried out advantages are ensured. Consequently, particularly a vehicle-specific vehicle electrical system is able to be protected when there is a voltage drop. This is particularly advantageous in the development of the braking system described here, since reservoir charging pump 10 is used only for charging pressure sensor 14, by the use of which improved operating convenience and/or a more agreeable brake feel (pedal feel) is ensured for the driver. However, a driver would be pleased to do without such improvements if thereby a sufficient energy supply of more essential vehicle components were ensured in case of a voltage drop.

1-12. (canceled)

13. A control device for a reservoir charging pump of a braking system of a vehicle, comprising:
an actuating device configured to selectively actuate the reservoir charging pump into at least one of a normal mode having a normal rotational speed and at least one deviation mode; and
a receiving device configured to receive a variable with respect to a supply voltage provided to the reservoir charging pump, the variable being provided by a vehicle-specific component;
wherein the actuating device is configured to (i) ascertain whether the received variable lies outside a specified value range for the normal mode, and (ii) if the received variable lies outside the specified value range for the normal mode, actuate the reservoir charging pump from the normal mode into the at least one deviation mode having at least one setpoint rotational speed deviating from a normal rotational speed of the normal mode.

14. The control device as recited in claim 13, wherein the actuating device is configured to (i) ascertain whether the received variable lies within a specified first deviation value range, and (ii) if the received variable lies within the specified first deviation value range, actuate the reservoir charging pump into a first deviation mode having a first setpoint rotational speed greater than the normal rotational speed of the normal mode.

15. The control device as recited in claim 14, wherein the actuating device is configured to (i) ascertain whether the received variable lies within a specified second deviation value range, and (ii) if the received variable lies within the specified second deviation value range, actuate the reservoir charging pump into a second deviation mode having a second setpoint rotational speed equal to zero.

16. The control device as recited in claim 15, wherein the actuating device is configured to (i) ascertain whether the received variable lies between the first deviation value range and the second deviation value range, and (ii) if the received variable lies between the first deviation value range and the second deviation value range, actuate the reservoir charging pump into a third deviation mode having a third setpoint rotational speed greater than the normal rotational speed of the normal mode, and wherein in the third deviation mode a startup of the reservoir charging pump is forestalled using the actuating device.

17. The control device as recited in claim 16, wherein the control device is part of the reservoir charging pump.

18. A braking system of a vehicle, comprising:
a reservoir charging pump;
a pressure reservoir in which a pressure is able to be built up using the reservoir charging pump; and
a control device for the reservoir charging pump, the control device including:
an actuating device configured to selectively actuate the reservoir charging pump into at least one of a normal mode having a normal rotational speed and at least one deviation mode; and
a receiving device configured to receive a variable with respect to a supply voltage provided to the reservoir charging pump, the variable being provided by a vehicle-specific component;
wherein the actuating device is configured to (i) ascertain whether the received variable lies outside a specified value range for the normal mode, and (ii) if the received variable lies outside the specified value range for the normal mode, actuate the reservoir charging pump from the normal mode into the at least one deviation mode having at least one setpoint rotational speed deviating from a normal rotational speed of the normal mode.

19. The braking system as recited in claim 18, further comprising:
a master brake cylinder;
wherein the pressure reservoir is hydraulically connected to the master brake cylinder in such a way that an inner pressure in at least one pressure chamber of the master brake cylinder is raised using the pressure built up in the pressure reservoir.

20. The braking system as recited in claim 19, wherein the pressure reservoir is hydraulically connected to an antechamber of the master brake cylinder.

21. A method for operating a reservoir charging pump of a braking system of a vehicle, comprising:
operating the reservoir charging pump in a normal mode at a normal rotational speed;
ascertaining a variable with respect to a supply voltage provided to the reservoir charging pump;
determining whether the ascertained variable lies outside a specified value range for the normal mode; and
if the ascertained variable lies outside the specified value range for the normal mode, actuating the reservoir charging pump from the normal mode to at least one deviation mode having at least one setpoint rotational speed deviating from the normal rotational speed of the normal mode.

22. The method as recited in claim 21, further comprising:
determining whether the ascertained variable lies in a specified first deviation value range; and
if the ascertained variable lies within the specified first deviation value range, actuating the reservoir charging pump into a first deviation mode having a first setpoint rotational speed greater than the normal rotational speed of the normal mode.

23. The method as recited in claim 22, further comprising:
determining whether the ascertained variable lies in a specified second deviation value range; and
if the ascertained variable lies within the specified second deviation value range, actuating the reservoir charging pump into a second deviation mode having a second setpoint rotational speed equal to zero.

24. The method as recited in claim 23, further comprising:
determining whether the ascertained variable lies between the first deviation value range and the second deviation value range; and
if the ascertained variable lies between the first deviation value range and the second deviation value range, actuating the reservoir charging pump into a third deviation mode having a third setpoint rotational speed greater than the normal rotational speed of the normal mode, and wherein in the third deviation mode a startup of the reservoir charging pump is forestalled using the actuating device.
